(19) United States
(12) Patent Application Publication
(10) Pub. No.: US 2006/0080946 A1
(43) Pub. Date: Apr. 20, 2006

(54) Treeless riding saddle and method of making the same

(76) Inventor: Peter A. DeCosemo, Vancouver, WA (US)

Correspondence Address: Ingrid McTaggart, 1816 S.E. 54th Avenue, Portland, OR, 97215, US

(21) Appl. No.: 10/968,670

(22) Filed: Oct. 18, 2004

(51) Int. Cl. B68C 1/02

(52) U.S. Cl. 54/44.1

(57) ABSTRACT

One embodiment of a treeless saddle may include a non-rigid saddle body manufactured of flat, flexible material and having a smooth, continuous lower surface and a top surface that defines a seat region, a non-rigid back contacting pad secured to the lower surface of the saddle body, the back contacting pad defining a recessed gullet region extending along a central region of the saddle body, and a billet strap secured to the top surface of the saddle body.

### TECHNICAL FIELD

The present invention relates to a treeless riding saddle and a method of making the same, and more particularly, to a treeless riding saddle that provides a fully flexible saddle which conforms to and continuously contacts a horse's back during all types of movement, while simultaneously providing contoured support for a rider which enables the rider to fully communicate with the horse.

### BACKGROUND OF THE INVENTION

Throughout history saddles have facilitated riders in remaining mounted on their horse. Early saddles comprised a simple, flat saddle blanket secured to the back of a horse. This simple design facilitated the rider in remaining on the horse during calm movements, such as walking, but did not help the rider to remain on the horse during faster movements such as galloping or jumping. With the arrival of organized warfare a more substantial saddle was developed which included a rigid saddletree that anchored a soldier in the saddle and rendered him difficult to dislodge by his opponents.

These rigid saddletrees were thought to distribute the weight of the rider evenly over the horse's back by providing a frame that defined a gullet, i.e., a spacing of the saddle from the backbone ridge of the horse. This rigid frame design with a gullet was thought to ease the workload of the horse. Spacing of the rigid frame from the horse's backbone ridge was also thought to evenly distribute the weight of the rider. Rigid saddletrees were also thought to provide the rider with a stable support base from which to control the horse by providing a permanent arched shape to the saddle including a raised pommel, a raised cantle and a lowered seat area positioned therebetween. Due to these perceived benefits, rigid saddletrees have become standard in virtually all saddle designs.

In the environment of sport riding the rider is often subject to abrupt stops, starts or turns of the horse. During such abrupt movements, the rigid saddletree can be jammed into the horses back or shoulders. Such rigid saddletrees also limit “contact” of the rider's knees and inner thighs with the horse, thereby limiting communication between the horse and rider. Such rigid saddletrees may also decrease the performance of the horse and rider, cause pain to both horse and rider, cause behavioral problems by the horse, and in some cases, cause injury to the horse and rider.

### SUMMARY OF THE INVENTION

One embodiment of a treeless saddle may include a non-rigid saddle body manufactured of flat, flexible material and having a smooth, continuous lower surface and a top surface that defines a seat region, a non-rigid back contacting pad secured to the lower surface of the saddle body, the back contacting pad defining a recessed gullet region extending along a central region of the saddle body, and a billet strap secured to the top surface of the saddle body.

### BRIEF DESCRIPTION OF THE DRAWINGS

FIG. 1 is a perspective view of a prior art rigid saddletree;

FIG. 2 is a side view of one embodiment of the treeless riding saddle of the present invention;

FIG. 3 is a bottom view of the right half section of the saddle body;

FIG. 4 is a top perspective view of a knee roll;

FIG. 5 is a top view of the components used to make the knee roll of FIG. 4;

FIG. 6 is a top view of the right half section of the saddle body;

FIG. 7 is a top view of two half sections of the saddle body sewn together;

FIG. 8 is a top view of two billet straps secured to a half section of the saddle body;

FIG. 9 is a top view of two mirror image billet covers;

FIG. 10 is a top view of a billet cover sewn to a saddle body half section;

FIG. 11 is a top view of a bottom cover piece of the treeless saddle;

FIG. 12 is a bottom view of the two half sections of the saddle of FIG. 7, with the bottom cover piece sewn thereto;

FIG. 13 is a top view of the stirrup hangers;

FIG. 14 is a top view of the saddle of FIG. 12 with the stirrup hangers riveted thereto;

FIG. 15 is a top view of the saddle of FIG. 14 with the bottom cover piece edges pulled around and glued thereto, and a cantle foam piece and a pommel arch piece glued in position on the saddle;

FIG. 16 is a perspective view of the cantle foam piece;

FIG. 17 is a perspective view of the pommel arch piece;

FIG. 18 is a top view of the saddle of FIG. 15 with seat padding secured thereto;

FIG. 19 is a top view of the components of a pommel cover;

FIG. 20 is a top view of the pommel cover sewn together and positioned on the saddle of FIG. 17, with the ends of the stirrup hangers pulled therethrough;

FIG. 21 is a top view of the saddle of FIG. 20 with a saddle skirt sewn and riveted thereto;

FIG. 22 is a top view of the components of a seat cover;

FIG. 23 is a top view of the seat cover sewn together and secured to the saddle of FIG. 21;

FIG. 24 is a top view of a left side leg flap;

FIG. 25 is a side view of the saddle of FIG. 23 with the leg flap of FIG. 24 riveted and sewn thereto;

FIG. 26 is a top view of a sculpted back panel;

FIG. 27 is a side view of the back panel of FIG. 26;

FIG. 28 is a bottom view of the saddle of FIG. 25 with the bottom cover piece pulled to one side and one back panel glued in position;

FIG. 29 is a top view of a sculpted back foam piece;

FIG. 30 is a side view of the back foam piece of FIG. 29;

FIG. 31 is a bottom view of the saddle of FIG. 28 with one back foam piece secured to the sculpted back panel;

FIG. 32 is a bottom view of the saddle of FIG. 31 with both back panels and both back foam pieces secured in place and the bottom cover piece glued in position;

FIG. 33 is a top view of the components of a shoulder column;

FIG. 34 is a perspective view of the assembled shoulder column;

FIG. 35 is a top view of the components of a thigh block;

FIG. 36 is a perspective view of the assembled thigh block;

FIG. 37 is a top view of the components of a gullet pad;

FIG. 38 is a perspective view of the assembled gullet pad; and

FIG. 39 is a perspective view of the treeless riding saddle in use.

### DETAILED DESCRIPTION

Referring to FIG. 1, a prior art rigid saddletree 10, also called a tree or a frame, typically is positioned within the outer covering of a prior art saddle (not shown). Rigid saddletree 10 comprises two side bars 12 and 14, an arched front section 16, also called a pommel, and a contoured rear seat 18, also called a cantle. Side bars 12 and 14, pommel 16, and cantle 18 are manufactured of rigid material, typically wood or metal. In the prior art embodiment shown, the frame is manufactured of wood wherein steel braces 20, 22, 24 and 26 are fastened to the individual wooden pieces by fasteners 28 to rigidly secure the frame together. Front steel braces 20 and 22 also include rearward extending hooks 30 for the attachment of stirrups thereto (not shown) for support of the rider's feet. Pommel 16 may also include a steel support brace 32 to ensure the wooden arch holds its shape during use. Pommel 16 further includes two lower “points” 34 and 36.

In use, side bars 12 and 14 are placed along the back of the horse straddling the spine, wherein the weight of the rider forces the bars downwardly into the horses back and shoulders. This may inhibit the horse's performance and/or lead to injury of the horse's back or shoulders. The frame provides a rigid support base for the rider which isolates the rider from fully sensing the movements of the horse. Moreover, the rigid frame hinders the horse from sensing subtle movements of the rider. Accordingly, in general, the rigid frame inhibits communication between horse and rider.

When the rigid saddletree of the prior art is secured to a horse, the pommel part of the rigid tree is placed over or just rearwardly of, but still in contact with, the back edge of the horse's shoulder blade, also called a scapula, when the horse is in the standing position. The rigid saddletrees of the prior art cannot be placed more rearwardly on a horse because the horse's back becomes too flat so that side bars 12 and 14 would not contact the sides of the horse but instead would stand up on the horse's back.

Upon movement of the horse, the front legs of the horse move forwardly which rotates the scapula rearwardly and into or under the rigid saddletree. This contact of the horse's scapula with the rigid saddletree can be quite painful. When the horse gallops or canters, the hind end of the horse thrusts upward and forward, thereby thrusting the rigid saddletree and the rider forward. This movement further forces the rigid frame into the horse's shoulders. Moreover, the movement is exaggerated during rigorous riding when the horse may start or stop abruptly. In particular, lower pointed ends 34 and 36 of the pommel region dig into the horse's shoulders with each stride. When a rider places his weight on the stirrups, instead of on the saddle seat, the forward position of the stirrup hooks 30 causes rear cantle 18 to rise up above the horse's back, and causes front pommel 16, and points 34 and 36, to further dig down into the horse's shoulders. The rigid frame construction of the prior art does not allow one to position the saddle rearwardly of the horse's shoulder blades because the scapula acts as a brake on this forward movement of the saddle when weight is placed on the stirrups or when the horse runs.

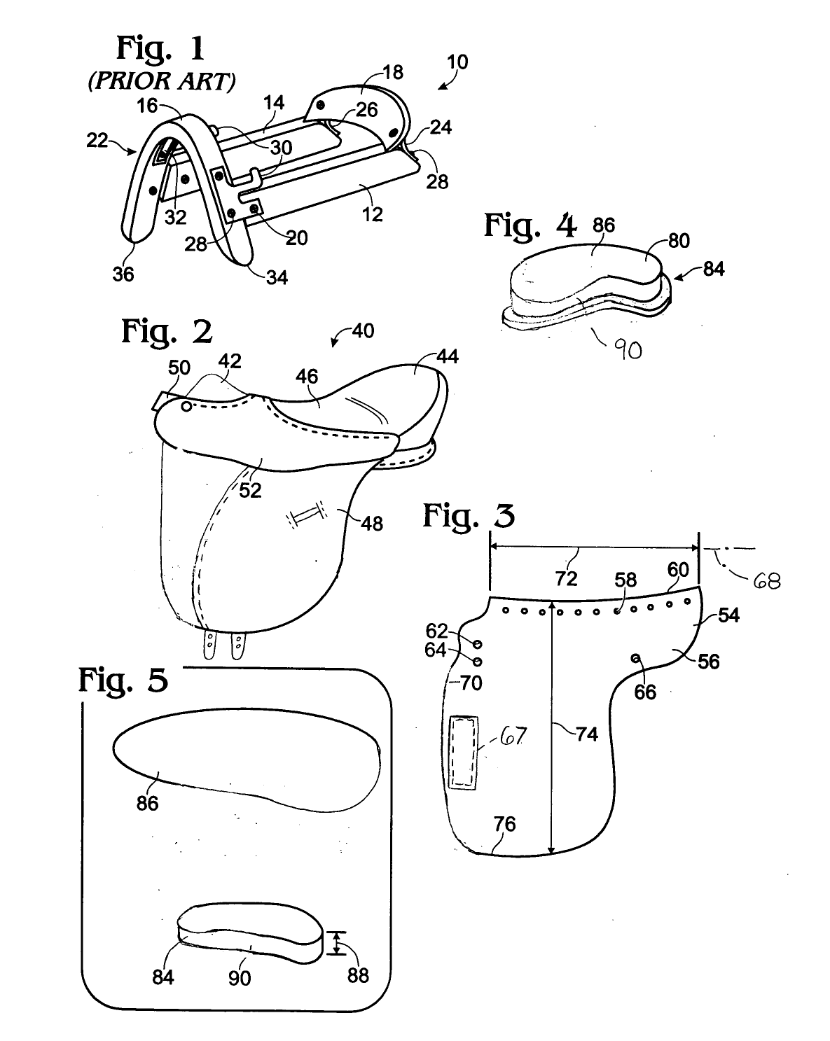

FIG. 2 shows a preferred embodiment of the flexible treeless saddle 40 of the present invention including an upwardly extending, riding style pommel 42, an upwardly extending cantle 44, and a lowered seat portion 46 positioned therebetween. The saddle further comprises an outer side flap 48, a gullet pad 50, and a skirt 52. The method of making the saddle of the present invention will be shown in a step by step fashion.

FIG. 3 shows an underside 54 of one half section 56 of two mirror image body half sections which are each cut from latigo chard, eight to nine ounce weight leather. The half section 56 shown is a right side piece, meaning that when the top of the completed saddle is viewed from the top, with the pommel of the saddle positioned forwardly from the cantle, half section 56 will be positioned on the right side of the saddle. As will be understood by those skilled in the art, the saddle of the present invention can be manufactured of any flexible material such as leather, flexible plastic, material, or the like, in any desired weight, strength, color or thickness. The saddle may also be manufactured in any size as is desired for a particular application. Accordingly, Applicant describes herein one method of making the inventive saddle according to one embodiment but is not limited to this particular embodiment. Moreover, many of the steps of the method of the present invention involve mirror image steps wherein only one of the mirror image steps is described for the sake of brevity.

Half section 56 is punched with stitching apertures 58 along an upper edge 60 of the section (typically eleven stitching apertures are punched), D-ring aperture 62 in a forward portion of the section, side flap aperture 64 below D-ring aperture 62, and a second side flap aperture 66 in a rear portion of the half section. A fastener 67, such as hook or pile material, is sewn to half section 56, for securing a shoulder block (see FIG. 24) thereto. Forward edge 70 of half section 58 may be described as being substantially straight or flat, or extending substantially vertically downwardly or substantially perpendicularly relative to an elongate axis 68 of saddle 40. When gluing components of the saddle, typically quick drying all purpose rubber cement is used, though other adhesives may also be used. The half sections typically have a width 72 measured along upper edge 60 of approximately seventeen (17) inches, and a length 74 measured from upper edge 60 downwardly to a lower edge 76 of approximately eighteen and a half (18.5) inches.

FIGS. 4 and 5 show the components of knee roll 80. Knee roll 80 includes an insert 84 of multipurpose low-density continuous rolled foam (hereinafter referred to as “MLC foam”) and a soft leather cover 86. The soft leather typically comprises tumble soft pebble, four to five ounce weight leather, but other softness and weights of durable material may be used. Pre-molded insert 84 typically has a thickness 88 of approximately one and a half (1½) inches and a contoured shape for receiving a rider's knee in a recessed region 90 thereof. Soft leather cover 86 is first sewn to the front edge of saddle body 106. Insert 84 is then glued on top of billet cover 126 (see FIG. 10). Cover 86 is then stretched and glued over insert 84 and sewn into position on saddle body 106.

FIG. 6 shows a top side 92 of right half section 56 of the saddle. A fastener 94 is glued and sewn to top side 92 adjacent a rear edge 96. Fastener 94 typically comprises a five point five (5.5) inch long strip of hook or pile material (corresponding mating hook or pile material is sewn to the underside of a thigh block, as will be described in more detail below). In this embodiment, fastener 94 is sewn to section 56 with the top portion of the fastener positioned approximately three point five (3.5) inches down from rivet hole 64. Knee roll 80 is sewn to top side 92, adjacent front edge 70, and on an opposite side of section 56 from fastener 68. Knee roll 80 typically is secured to section 56 approximately one point five (1.5) inches down from forward side flap aperture 64. In another embodiment, a fastener (not shown), such as hook or pile material, may be secured on half section 56, such as by gluing, just rearwardly of forward edge 70 so that a knee roll 80 (see FIGS. 4 and 5) may be releasably secured thereto. A D-ring 98 is then secured to section 56 by a strip of leather 100 riveted to aperture 62. A stitch line 102, shown in dash lines, is then marked approximately one point five (1.5) inches below upper edge 60 of section 56. Stitch line 102 marks where a bottom cover (not shown) will be sewn to the half sections of the saddle later in the assembly process. This process is then repeated for the second, left half section of the saddle (not shown).

FIG. 7 shows two half body sections 56 and 104 sewn together using artificial sinue thread by stitching 105. The stitching is tied off individually at each of apertures 58 aligned along top edge 60 of each of the half sections. When the two half sections are sewn together they define a central saddle body 106. Central saddle body 106 does not lay completely flat because upper edge 60 of each of the half body sections has a slight curvature (shown in FIG. 3). Accordingly, central saddle body 106 has a slightly arched shape along its central seam 108. The saddle body can be described as defining a smooth, continuous arched underside, wherein “smooth and continuous” includes embodiments where several pieces of material are secured together to define the saddle body.

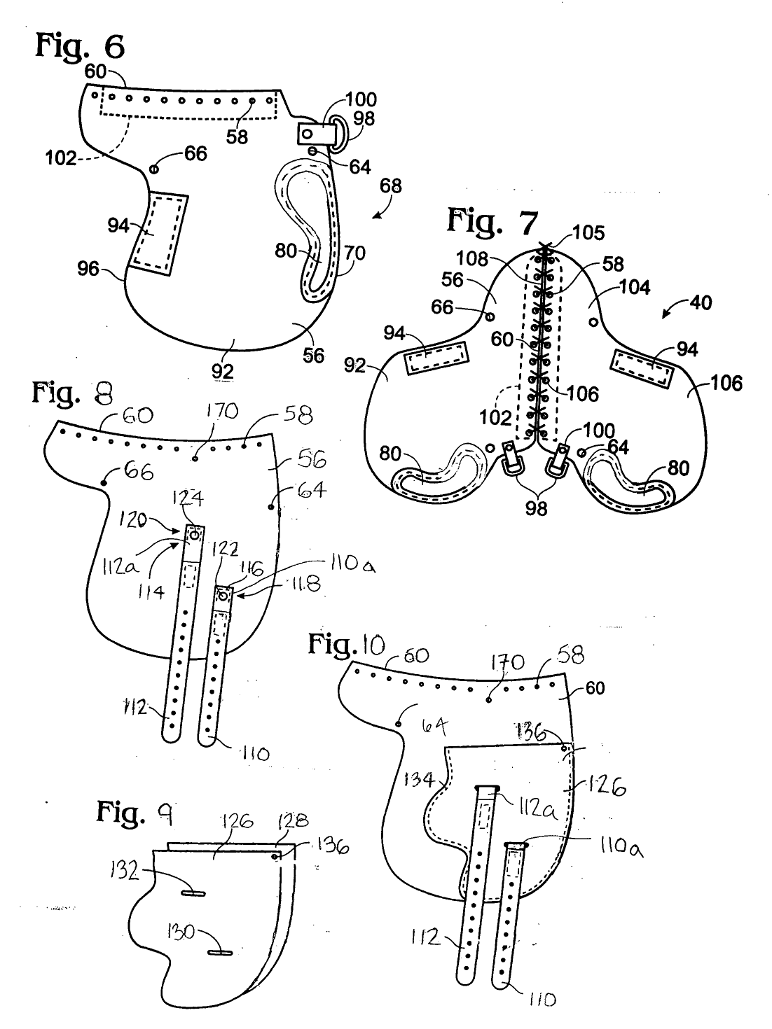

FIG. 8 shows body half section 56 wherein billet straps 110 and 112 have been sewn to webbing 110a and 112a by stitching. The webbing may be nylon webbing similar to that used for automobile safety seat belts. Webbings 10a and 112a may be glued in place around rivet holes 114 using quick drying all purpose cement. The webbings are then stitched to half section 56 by stitching 116 and are riveted in place at billet strap rivet apertures 118 and 120 by rivets 122 and 124. Rivets 122 and 124 typically comprise copper number 9, three quarters inch long rivets. Attachment of the billets straps 110 and 112 to half sections 56 and 104 by the use of webbings 110a and 112a allows the billets straps to be changed out when worn, without removing billet covers 126 and 128 (see FIG. 9).

FIG. 9 shows mirror image billet covers 126 and 128 cut from tumble soft pebble, four to five ounce weight leather. Billet strap apertures 130 and 132 are cut or punched in each billet cover. In another embodiment, suede may be used instead of the tumble soft pebble leather for billet covers 126 and 128.

FIG. 10 shows billet cover 126 glued and stitched by stitching 134 to half body section 56 wherein billet straps 110 and 112 are pulled through apertures 130 and 132, respectively. This process is then repeated for the second billet cover and half body section. A rivet aperture 136 is punched in each of the billet covers, the apertures being aligned with apertures 64 of each of the half body sections.

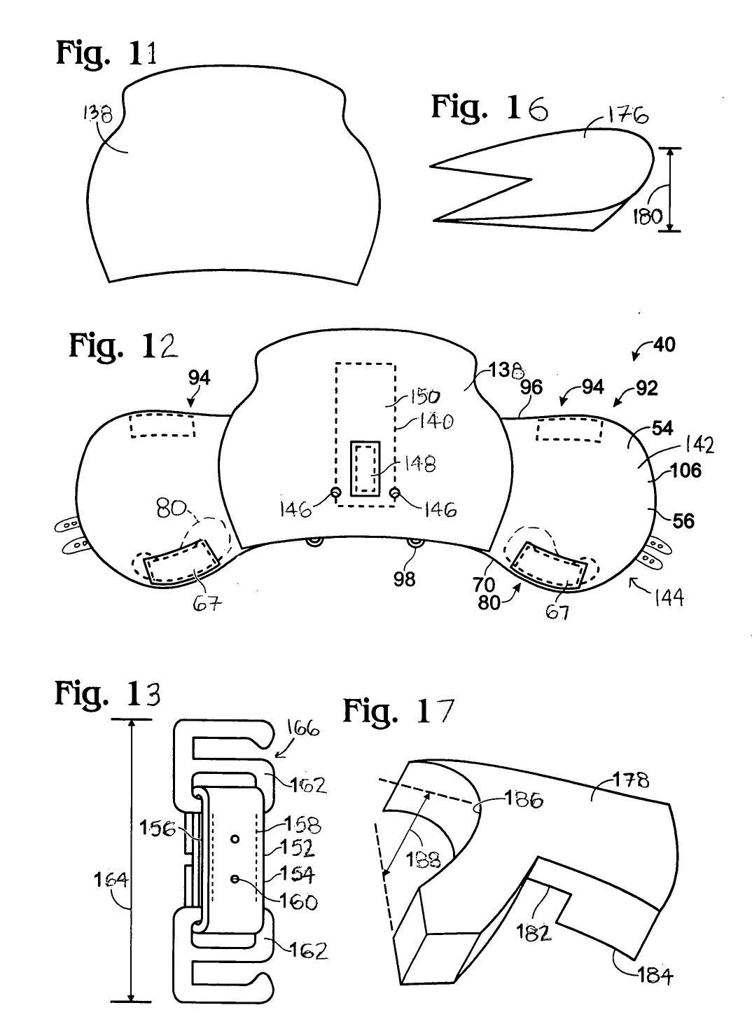

FIG. 11 shows a top view of a bottom cover piece 138 of the treeless saddle. Bottom cover piece 138 typically is cut from heavy pebble leather.

FIG. 12 shows bottom cover piece 138 glued and sewn in place, by stitching 140, on underside 142 of saddle body 106. The bottom cover piece 138 is generally sewn to the saddle body with topside 144 of the saddle body 106 facing upwardly, wherein stitching 140 is made along previously marked stitch lines 102 (shown in FIG. 7). Two rivet holes 146 are punched through bottom cover piece 138 and through half sections 56 and 104. Rivet holes 146 will be used for securing the stirrup hangers (not shown) to the saddle body later in the assembly process. A fastener 148 is then glued and sewn within a region 150 defined by stitching 140, wherein region 150 will become the gullet region of the saddle. Fastener 148 typically is sewn within region 150 approximately one (1) inch rearwardly from rivet holes 146. Fastener 148 typically is a five point five (5.5) inch long piece of hook or pile material, wherein mating hook or pile material is sewn to a gullet pad, as will be described later in the process, such that a removable and adjustable gullet pad may be secured within gullet region 150.

FIG. 13 shows a stirrup hanger 152, also referred to stirrup hangers, made from a long leather strap 154 and a short leather strap 156 stitched together by stitching 158 and including rivet apertures 160. Each of straps 154 and 156 has a width of approximately one point two five (1.25) inches. The long leather strap captures two break-away stirrup hanger bars 162, which typically are manufactured of a pre-cast, durable and strong material such as metal. Each of the bars 162 measures approximately one (1) inch by one (1) inch and stirrup hanger 152 typically has a length 164 of approximately four (4) inches. Each of bars 162 includes a recess 166 for receiving a stirrup strap as will be understood by those skilled in the art. A rear portion of the recess of bars 162 is open thereby allowing the stirrups to “breakaway” during times of emergency.

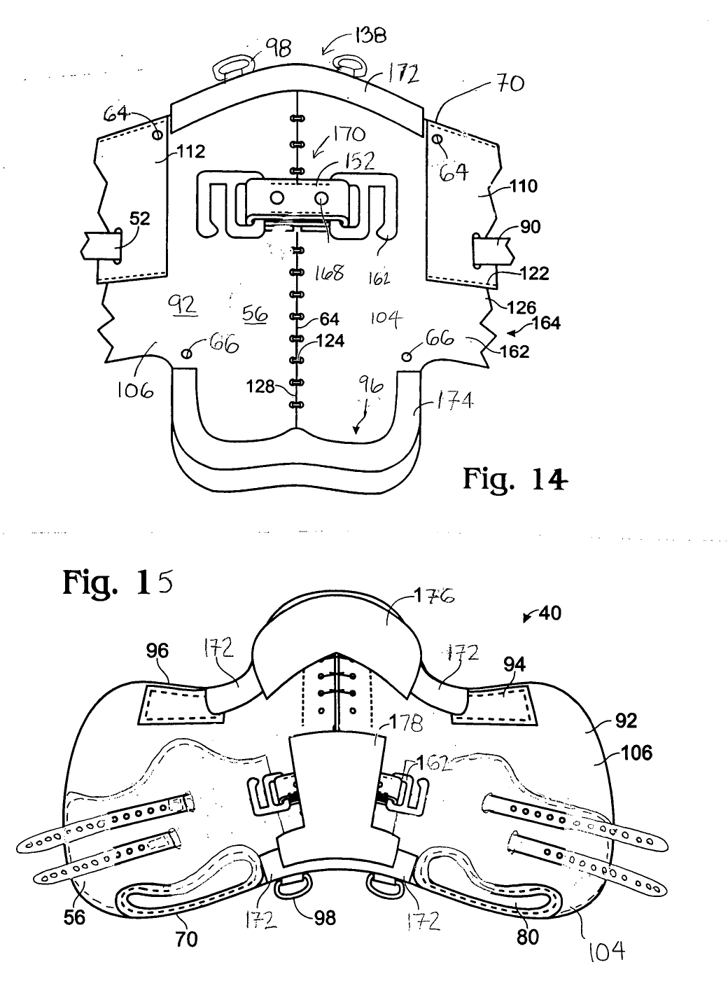

FIG. 14 shows stirrup hanger 152 secured to saddle body 106 by rivets 168 positioned through rivet holes 160 in the stirrup hangers and through rivet holes 170 (shown in FIG. 8) punched through bottom cover 138 (see FIG. 12) and through saddle body portions 56 and 104. Rivets 168 typically comprise one (1) inch polished copper rivets which are riveted upwardly from the underside 54 of the saddle body through to the topside 92 of the saddle body 106.

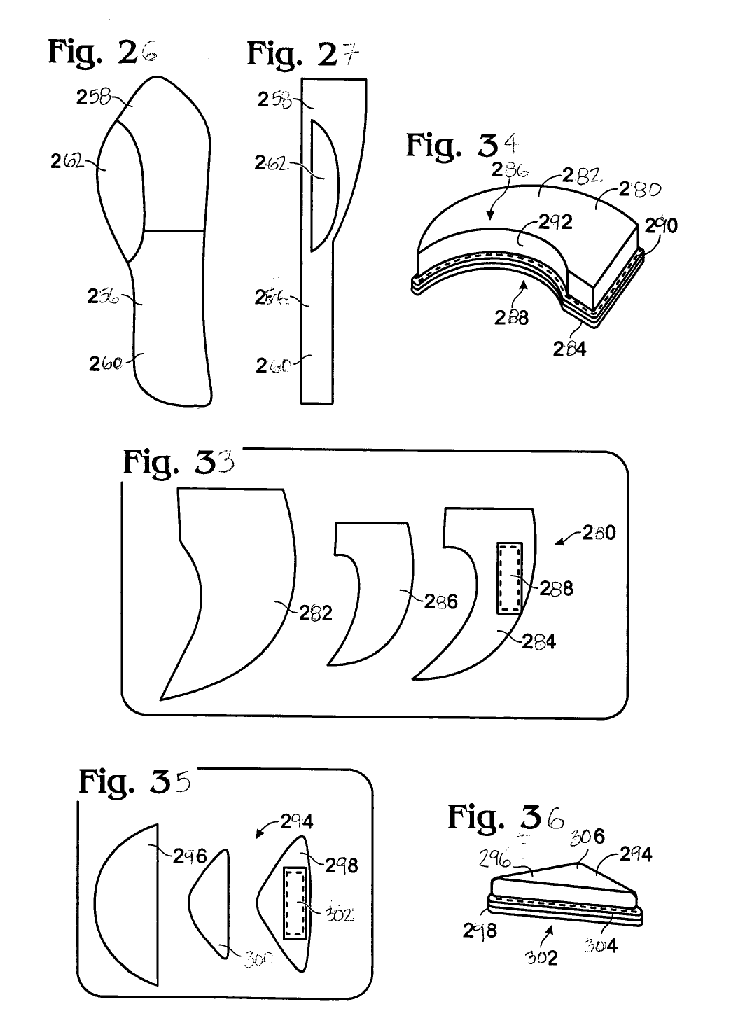

Still referring to FIG. 14, a front binding 172 and a back binding 174 are secured in place. In particular, front binding 172 comprises the front edge of bottom cover 138 (shown in FIG. 11) which is pulled over and around front edge 70 of saddle body 106 and glued to topside 92 of the saddle body 106. Back binding 174 comprises the rear edge of bottom cover 138 (shown in FIG. 11) which is pulled over and around rear edge 96 of saddle body 106 and glued to topside 92 of the saddle body 106. The edge of bottom cover 138 in regions 172 and 174 are trimmed as needed before gluing to topside 92 of the saddle body. When securing front binding 172 in place, two slits are made within bottom cover 138 so that D-rings 98 (see FIG. 7) may protrude therethrough. In another embodiment, bindings 172 and 174 may be secured in place later in the process, so as to cover additional layers such as pommel cover 194 (see FIG. 23) or seat back 224 (see FIG. 23).

FIG. 15 shows formation of the pommel and cantle regions of the saddle. After securing bindings 172 and 174 in place, a seat or cantle piece 176 is glued to a rear region of the saddle body and a pommel piece 178 is glued to a forward region of topside 92 of saddle body 106.

FIG. 16 is a perspective side view of cantle piece 176. Cantle piece 176 typically is pre-molded from 2-PPM and defines a height 180 of approximately four (4) inches. Cantle piece 176 defines a raised rear section of the finished saddle, which generally will be positioned higher than a seat portion of the finished saddle.

FIG. 17 is a perspective side view of pommel piece 178. Pommel piece 178 typically includes a cutout region 182 on a lower side 184 thereof, wherein cutout region 182 fits over stirrup hanger 152 (shown in FIG. 13) when the pommel piece is secured to the saddle body. Pommel piece 178 further includes a second cutout region 174 that defines the front cutout shape of the finished riding saddle in the pommel region. Cutout pommel region 186 allows the riding saddle to be positioned on the horse's back without restricting movement of the neck of the horse. Pommel piece 178 may be pre-molded from 2-PPM or may be manufactured of foam. Pommel piece 178 typically defines a height 188 of approximately two (2) inches.

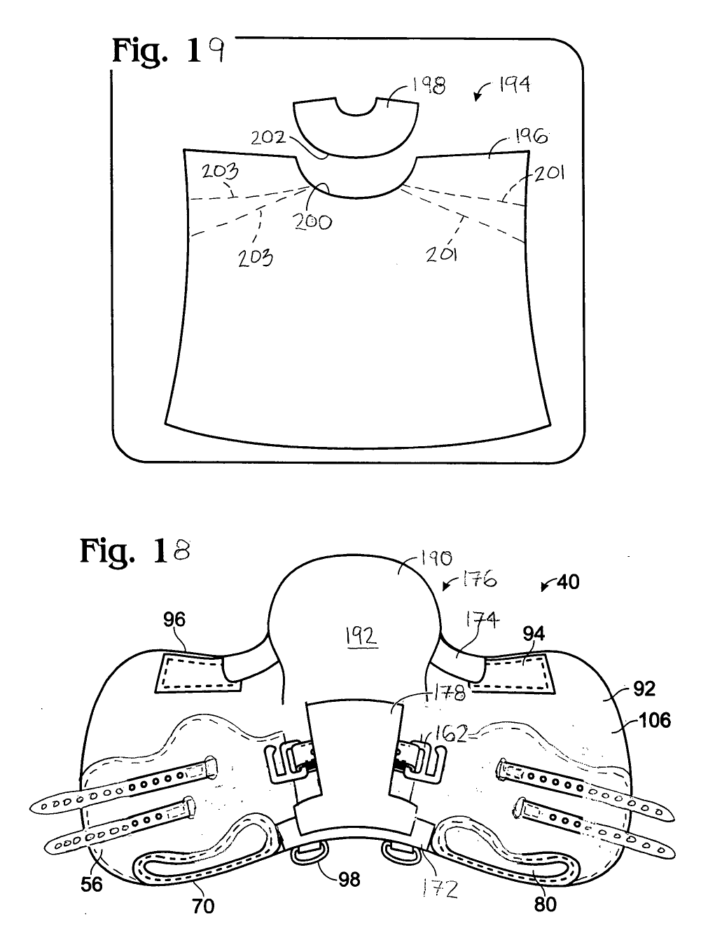

FIG. 18 shows a seat piece 190 positioned and glued on top of cantle piece 176 (shown in FIG. 15) and in a central region 192 of topside 92 of saddle body 106. Seat piece 190 typically is manufactured of point five (0.5) inch thick MLC foam. Other flexible materials besides foam may also be used.

Cantle piece 176, seat piece 190, and pommel piece 178, therefore, define a raised rearward section and a raised forward section, respectively, of the completed saddle, which thereby defines a lower seat portion of the finished saddle. In other words, the raised pommel and cantle define therebetween a contoured seat region, also called a recessed or a form-fitting seat region. Accordingly, the treeless saddle of the present invention defines a flexible saddle that allows communication between horse and rider, yet still provides a contoured shape for securely holding a rider therein.

FIG. 19 shows a top view of the components for making a pommel cover 194, including a top pommel piece 196 and a front pommel piece 198. Pommel cover 194 is made by sewing top piece 196 to front piece 198 along curved edges 200 and 202, on the bottom side of the pommel pieces. Top piece 196 may be cut along dash lines 201 and 203. Cut lines 201 may then be sewn together on an underside to form a dart and cut lines 203 may be sewn together on an underside to form a second dart. The darts allow pommel cover 196 to be positioned smoothly on arched pommel 178 (see FIG. 17). Accordingly, the finished pommel piece will have the stitching hidden on an underside thereof.

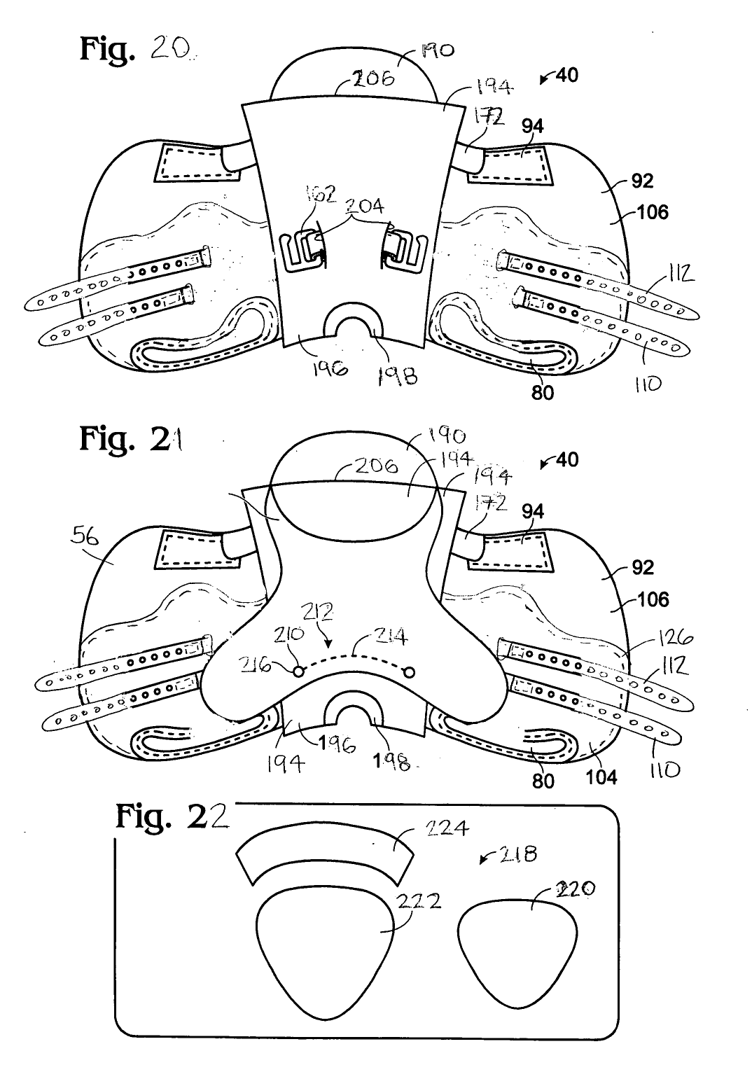

FIG. 20 shows pommel cover 194 positioned on the saddle of FIG. 18, with two slits 204 cut through pommel cover 194, which allow stirrup hanger bars 162 to protrude therethrough. As will be understood by those skilled in the art, the order of the steps of the present invention can be changed while still resulting in the saddle of the present invention. Accordingly, the order of the steps as recited herein is merely a recitation of the preferred method but other orders of steps may also be used. For example, the stirrup hanger holes can be punched in the pommel cover before or after the pommel cover is secured to the saddle body or before the pommel cover itself is sewn together. The pommel cover may be glued in place on pommel 178 (FIG. 18) with quick drying all purpose cement. In this glued position pommel cover 194 completely covers the pommel arch and extends downwardly to meet with the top region of billet cover 126. A rear edge 206 of pommel cover 194 extends rearwardly over the front portion of seat pad 190.

FIG. 21 shows a skirt 208 having rivet holes 210 in a forward region 212 thereof. Skirt 208 may be cut from nine pound latigo leather, or any other such flexible and durable material. Skirt 208 is secured on saddle body 106, over pommel cover 194 by gluing the skirt to pommel cover 194, by stitching 214 in forward region 200, and by rivets 216 which extend through rivet holes 210 in skirt 208 and through pommel cover 194.

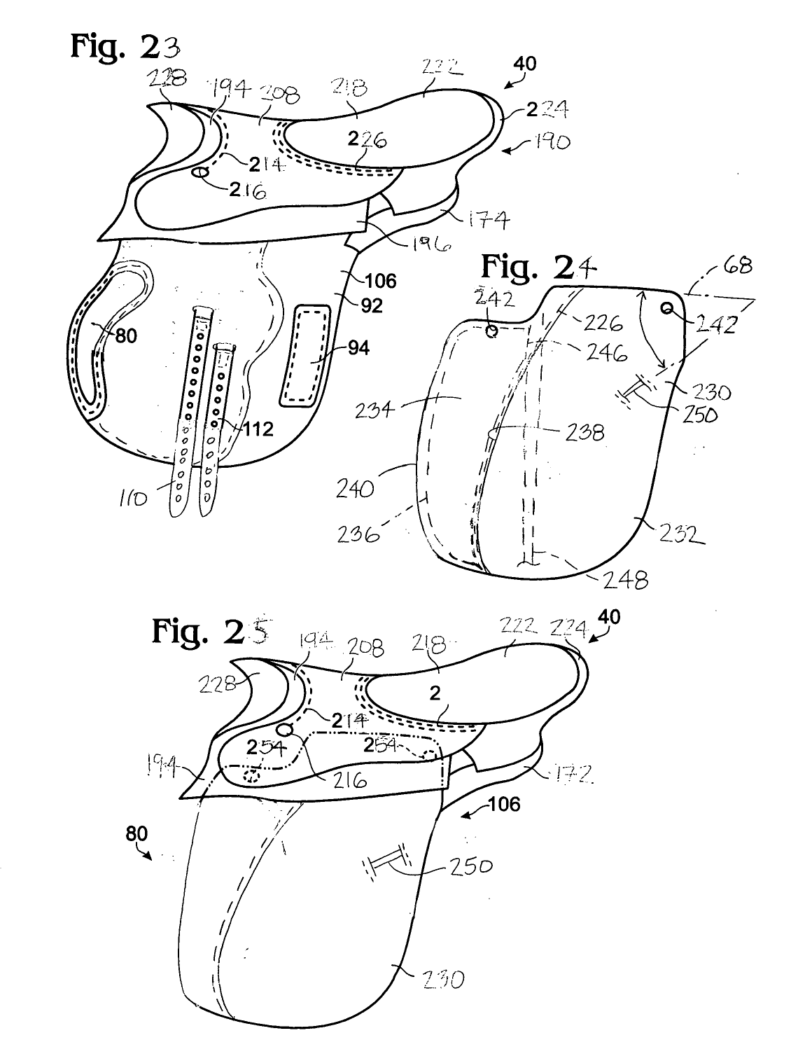

FIG. 22 shows the components of a seat cover 218 of the treeless saddle. The pieces include a cantle pad 220 made from cross linked polyethylene, one quarter (0.25) inch thick, two pound weight foam, a cantle cover 222 manufactured of tumble soft pebble, four to five ounce weight leather, and a seat back 224 manufactured of tumble soft pebble, four to five ounce weight leather. Cantle cover 222 is slightly larger than foam pad 220 and has the same diamond type shape. To assembly seat cover 218, pad 220 is glued to an underside of cantle cover 222. Seat back 224 is sewn to cantle cover 222 on an underside thereof so that when the seat cover is assembled, the stitching between cover 222 and back 224 is hidden on an underside thereof.

FIG. 23 shows assembled seat cover 218 positioned on saddle body 106 and in position for gluing thereto. Before gluing, back cover 224 is pulled upwardly and forwardly over cantle cover 222 so that the stitching is exposed and so that the cantle cover 222 is flat and smooth for gluing to seat padding 190 (see FIG. 18). With the cantle cover hand stretched and smoothed out over cantle pad 190, the cover is glued to pad 190, using quick drying all purpose cement, completely across the undersurface of cantle cover 222. Back cover 224 is then pulled rearwardly and downwardly over the rear edge of padding 190. The rear portion of skirt 208 is placed over seat cover 218 and glued and sewn thereto with stitching 226. The front portion 228 of pommel cover 194 is then glued to the front, upper surface 92 of saddle body 106 and front binding 172 (shown in FIG. 14).

FIG. 24 shows an assembled left side outer leg flap 230 including a leg panel 232, two pieces of padding cover 234 (only one padding cover can be seen in this view) having a generally triangular shape, and a pad 236 (shown in dash lines) positioned therebetween. Leg panel 232 may be manufactured of nine pound latigo leather, padding covers 234 may be manufactured of heavy pebble leather, and pad 236 may be manufactured of point five (0.5) inch thick MLC foam. To assembly leg flap 230, pad 236 is glued between covers 234. Covers 234 are then sewn together around their edges and along curved front edge 238 of leg panel 232 by stitching 226. When leg flap 230 is secured to saddle body 106, a front edge 240 of padding covers 234 are generally positioned substantially perpendicular to elongate axis 68 of saddle 40, such that front edge 240 is substantially vertical. Rivet holes 242 are punched in flap 230, wherein the rivet holes are positioned within the flap so as to align with corresponding sets of rivet holes 64 and 66 (shown in FIG. 14) of saddle body 106.

Still referring to FIG. 24, pad 236, shown in dash lines, includes an upper region 244 that defines a substantially vertical rear surface 246 of pad 236. Pad 236 extends outwardly from body 106 of the saddle such that rear surface 246 defines an outwardly extending stop surface that inhibits stirrup leather straps 248 (shown in environmental dash lines) from moving forwardly of rear surface 246. Accordingly, pad 236, including substantially vertical rear surface 246, may help position the stirrups of a rider during use of saddle 40.

Leg flap 230 may further include a stirrup keeper 250 for keeping the loose ends of stirrup leathers (not shown) when stirrups are secured to saddle 40. Stirrup keeper 250 may define an acute angle 252 of approximately forty five (45) degrees relative to elongate axis 68 of saddle 40, wherein stirrup keeper 250 may be seen to rise upwardly toward a rear region of leg flap 230. The inclined positioned of stirrup keeper 250 may position a stirrup leather (not shown) flat against leg panel 232 when saddle 40 is in use.

FIG. 25 shows left leg flap 230 secured to the saddle of FIG. 23 by two rivets 254 (shown in dash lines, positioned underneath skirt 208) and by stitching that extends between the two rivets. Leg flap 230 covers the lower portion of saddle body 106 such that knee roll 80 (FIG. 23), fastener 94 and billet straps 110 and 112 are covered by leg flap 230.

FIGS. 26 and 27 show a top view and a side view, respectively, of a sculpted back panel 256. Back panel 256 includes a top portion 258 having a thickness greater than a thickness of a lower portion 260, such that top portion 258 slopes downwardly toward lower portion 260. A portion of the panel is cut, sanded or otherwise shaped to define a recessed region 262, also referred to as a sculpted region, which receives the rider's inner thigh, i.e., which allows the rider's inner thigh to be in close communication and contact with the horse. In other embodiments the panel may be pre-molded to have such a sculpted region 262. Sculpted region 262 is cutaway from the remainder of the panel so that when back panel 256 of the saddle is placed on a horse's back, sculpted region 262 will allow for close contact of the rider's thigh with the horse's back or dorsal region. Panel 256 may be manufactured of point five (0.5) inch thickness cross linked polyethylene foam (hereinafter referred to “XPE foam”) glued together to define the thickness of the panel. Top portion 258 typically has a thickness of one point five (1.5) inches whereas lower portion 260 typically has thickness in a range of point five to one (0.5 to 1.0) inches. Prior to gluing to the underside of the saddle, the edge of back panel 256 may be sanded or smoothed, so as to provide for a smooth edge for contact with the horse's back and shoulders.

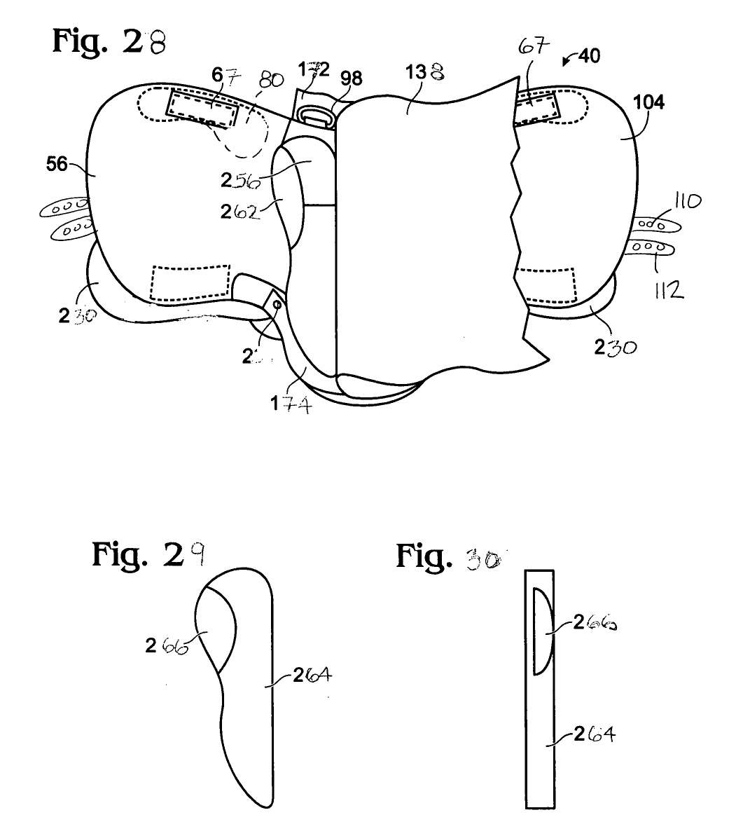

FIG. 28 is a bottom view of the treeless saddle wherein sculpted back panel 256 is glued to underside 54 of right half section 56. To glue back panel 256 to section 56, bottom cover piece 138 is pulled to one side. Cover piece 138 is not completely removed because it has been sewn to saddle body 106 by stitching 140 in gullet region 150 (shown in FIG. 12). The cover piece is then pulled to the other side to glue the other sculpted back panel in place on the left half section 104.

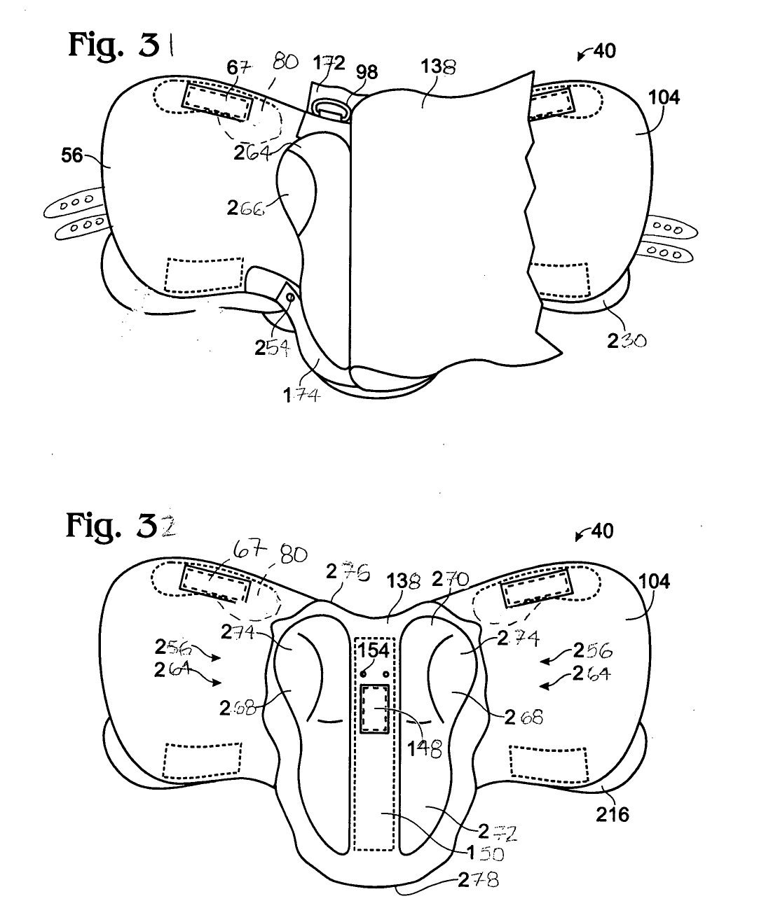

FIGS. 29 and 30 show a top view and a side view, respectively, of a sculpted back pad 264 having a cutout or sculpted region 266. Back pad 264 may be manufactured of point five (0.5) inch thick MLC foam. Sculpted region 266 generally has a thickness approximately half of that of the remainder of the pad and is positioned to be aligned with sculpted region 262 of back panel 256 (shown in FIG. 28).

FIG. 31 shows a bottom view of the treeless saddle wherein sculpted back pad 264 is glued to back panel 256 on right half section 56 of the treeless saddle. Once again, bottom cover piece 138 is pulled to one side as each back pad is glued to its corresponding back panel.

FIG. 32 shows a bottom view of the treeless saddle wherein bottom cover piece 138 is stretched over back pads 264 and back panels 256, and is glued and sewn in place on saddle body 106. After the bottom cover 138 is secured in place, the bottom side of the saddle defines recessed gullet region 150 positioned between outwardly extending back contacting regions 268. Back contacting regions 268 each extend outwardly from the saddle body a greater distance in forward region 270 than in a rearward region 272. This difference in the thickness of the back panels and pads compensates for the forces applied to the shoulder region of the saddle and horse during riding, such as when the full weight of the rider may be supported by the horse's shoulders as the horse comes to an abrupt halt. Moreover, back contacting regions 268 each include a sculpted or cutaway region 274 that provides for close contact of the rider's inner thigh with the horse's back.

Still referring to FIG. 32, after bottom cover 138 is secured in place around back contacting regions 268, a front edge 276 of the bottom cover 138 is pulled upwardly and over the front edge of the saddle. Pommel cover 172 (FIG. 31) is then pulled forwardly and downwardly around the front edge of the saddle, and over the front edge 276 of bottom cover 138. The front edge of the saddle is then glued and sewn. Similarly, a back edge 278 of bottom cover 138 is pulled upwardly and over the rear edge of the saddle. Cantle back cover 224 (FIG. 23) is then pulled rearwardly and downwardly around the rear edge of the saddle, and over the rear edge 278 of bottom cover 138. The rear edge of the saddle is then glued and sewn. This results in the finished saddle body shown in FIG. 2, although additional components may still be removably added to the saddle. These additional components will be addressed in the remaining figures.

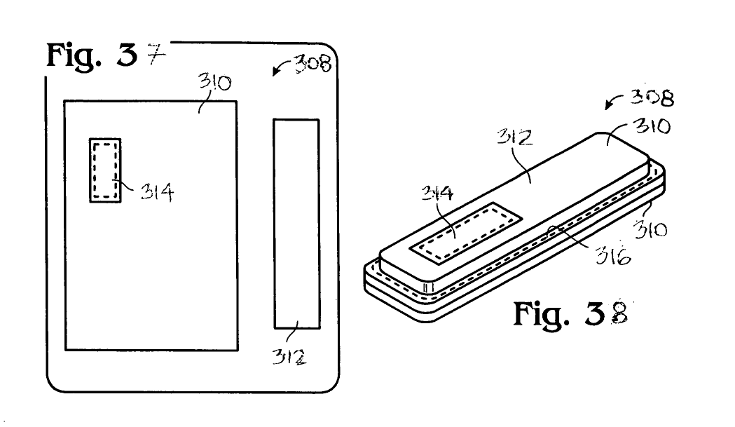

FIGS. 33 and 34 show the components and the assembled version, respectively, of a shoulder column 280. Column 280 includes a top piece 282, a bottom piece 284, and a shoulder column pad 286. Top piece 282 and bottom piece 284 may be manufactured of heavy pebble leather, and pad 286 may be manufactured of one (1) inch thick MLC foam. A fastener 288, such as a five point five (5.5) inch long strip of hook or pile material typically is sewn to a bottom surface of bottom piece 284. The shoulder column is secured together with pad 286 glued between the top piece 282 and the bottom piece 284, and the top and bottom pieces sewn together along their edges with stitching 290. Shoulder column 280 defines a contoured region 292 shaped to receive the knee of the rider while still conforming to the rearward curve of the horse's shoulder. Fastener 288 is positioned on an underside of shoulder column 280 so that the fastener may be releasably and adjustably secured to fasteners 67 (shown in FIG. 32) on the underside 54 of each of half sections 56 and 104 of saddle body 106. In this manner, additional padding and thickness may be added to the forward region of the treeless saddle.

FIGS. 35 and 36 show the components and the assembled version, respectively, of a rear thigh block 294. Thigh block 294 includes a top piece 296, a bottom piece 298, and a thigh block pad 300. Top piece 294 may be manufactured of soft leather, bottom piece 296 may be manufactured of nine pound latigo leather, and pad 300 may be manufactured of one (1) inch thick, pre-molded 2-PPM. A fastener 302, such as a three point five (3.5) inch long strip of hook or pile material typically is sewn to a bottom surface of bottom piece 298. The thigh block is secured together with pad 300 glued between the top piece 296 and the bottom piece 298, and the top and bottom pieces sewn together along their edges with stitching 304. Thigh Block 294 defines an outwardly extending corner region 306 shaped to be received within the back region of the rider's bent knee. Fastener 302 is positioned on an underside of thick block 294 so that the fastener may be releasably and adjustably secured to fasteners 94 (shown in FIG. 23) on the topside 92 of each of half sections 56 and 104 of saddle body 106, while remaining hidden from view under leg flaps 230. The corner 306 of the thigh block is generally positioned pointing toward the front the saddle. In this manner, additional padding and thickness may be added to the rearward region of the treeless saddle which may correctly position the rider's legs relative to leg flap 230 during riding.

FIGS. 37 and 38 show the components and the assembled version, respectively, of a gullet supplement 308. Gullet supplement 308 includes a cover piece 310 and a gullet pad 312. Cover piece 310 may be manufactured of soft leather and gullet pad 312 may be manufactured of one (1) inch thick, seventeen (17) inch long, three (3) inch wide MLC foam. A fastener 314, such as a five point five (5.5) inch long strip of hook or pile material typically is sewn to an outer surface of cover piece 310. The gullet supplement is secured together with cover piece 310 wrapped around pad 312, the pad 312 glued within the cover piece, and cover piece 310 sewn together along its edge with stitching 316. Gullet supplement 308 typically is manufactured so as to fit within gullet region 150 (shown in FIG. 32) of the underside of the treeless saddle. Fastener 314 is positioned on an underside of gullet supplement 308 so that the fastener may be releasably and adjustably secured to fastener 150 (shown in FIG. 32) in gullet region 150. In this manner, additional padding and thickness may be added to the gullet region of the treeless saddle in cases where a rider desires the saddle to conform to the entire back of the horse, such as when the horse is particularly wide in its withers region. In situations where the rider desires the saddle to sit slightly upwardly from the spine of the horse, the gullet supplement may be removed, such as when the horse is particularly narrow in its withers region. Accordingly, the gullet supplement 308 gives the rider added lateral stability within the saddle, depending on the build of their horse.

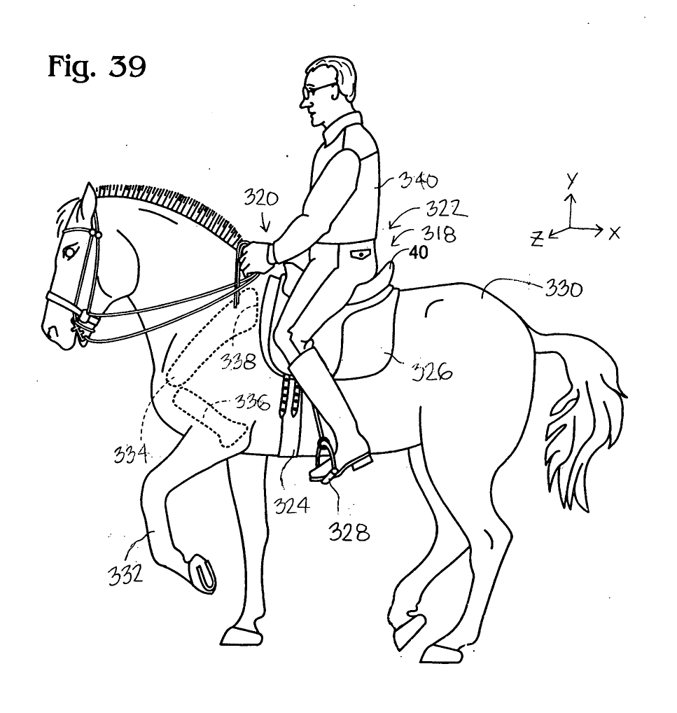

FIG. 39 shows the fully assembled, treeless, flexible saddle 40 of the present invention secured to a horse during riding thereof. Due to the lack of a rigid frame or tree, saddle 40 is capable of movement in all directions, i.e., along each of the x, y and z axes such that the saddle may be bent and folded in virtually every direction. In other words, a cantle region 318 is capable of upwardly forward movement toward a pommel region 320, and pommel region 320 is capable of upwardly rearward movement toward cantle region 318. Such movement, or flexure, of the saddle will tend to lower a seat region 322 with respect to the upwardly extending pommel and cantle regions. The cantle and pommel regions are also capable of downward and outward movement in opposite directions so that the saddle will tend to become relatively flatter or more stretched out when needed. Such movement of the saddle may occur during galloping or jumping of a horse on which the saddle is mounted. Saddle 40 of the present invention can also be twisted such that a left portion of cantle region 318 is bent toward a right portion of pommel region 320, or a right portion of cantle region 318 may be bent toward a left portion of pommel region 320. This twisting of the saddle may occur during tight or abrupt turns of the horse. Regardless of the flexure or contortions through which the saddle moves, seat region 322 generally will be positioned lower than pommel region 320 and cantle region 318 such that the rider fits comfortably and securely within the contoured seat region of the saddle. The raised positioning of the pommel and cantle of the present invention, which forms a contoured seat for the rider, is due to foam pads, rather than the upward extensions of a rigid frame or tree.

The riding saddle, as shown with reference to the embodiment described, further includes many adjustable and removable features which provide for added contoured support of the rider, without the use of a rigid saddletree to provide such a contoured shape. In particular, saddle 40 includes removable and adjustable thigh blocks 294 (FIG. 36), shoulder columns 280 (FIG. 34) and a gullet supplement 308 (FIG. 38). The treeless saddle 40 further includes back contacting regions 268 (FIG. 32) which provide room for the horse's spine therebetween, and each back contacting region defines a sculpted region 266 (FIG. 32) that provides room for the horse's shoulders. The removable gullet supplement may be positioned within the space between back contacting regions 268 to define a saddle that contacts the horse across its entire back.

Due to the slight curvature of upper edges 60 of the half body sections, central seam 108 of the saddle body has an arched shape similar to that of a horse's back. Accordingly, the treeless saddle of the present invention generally retains its arched shape without the need for a rigid tree or frame. Moreover, the side panels of the saddle may each move inwardly or outwardly to accommodate horses of varying sized girths, and to move in response to breathing and striding of the horse.

Due to the treeless, flexible nature of saddle 40, the only material positioned between the rider and the horse is flexible leather and foam pads. This construction provides increased comfort to both horse and rider and reduces the chance of injury to the horse's back or shoulders. Moreover, due to the flexible nature of the saddle, which moves in conformity with each and every movement of the horse, the treeless flexible saddle of the present invention allows a rider to instantly feel the horse's movements, and allows the horse to instantly sense the movements of the rider, thereby allowing the rider to ride in a state of complete harmony and communication with his horse.

The leather pieces of the saddle of the present invention typically are a classic brown leather color. However, other colors or types of leather, and other durable materials may be used for manufacture of the saddle. Moreover, the saddle of the present invention may be manufactured in any size and with modifications to the method described herewith, while still retaining the invention features of the present invention.

Referring still to FIG. 39, saddle 40 is shown secured by a girth strap 324 on a horse, with a soft saddle pad 326 positioned between the saddle and the horse. Stirrups 328 are secured to the stirrup hangers 162 (FIG. 20). The saddle preferably is secured to the horse rearwardly of the scapula of the horse, by at least two (2) inches, when the horse is in the standing position. However, during riding conditions the horse 330 may elevate its front leg 332 such that its scapula 334 is rotated rearwardly, also referred to a posterior oscillation of the scapula. The humerus 336 is rotated forwardly thereby closing the angle between the scapula and the humerus. In this elevated leg position, a rear edge of scapula 338 is positioned forward of saddle 40. Accordingly, the saddle provides room for movement of the horse's shoulder so that the saddle does not hinder movement of the horse. The raised pommel and cantle are also shown providing a contoured seat area for receiving a rider 340.

While preferred embodiments of the present invention have been shown and described, it will be apparent to those skilled in the art that many changes and modifications may be made without departing from the invention in its broader aspects. The appended claims are intended to cover, therefore, all such changes and modifications as fall within the true spirit and scope of the invention.

I claim:

1. A flexible, treeless saddle comprising:
a non-rigid saddle body manufactured of flat, flexible material and having a smooth, continuous lower surface and a top surface that defines a seat region;
a non-rigid back contacting pad secured to said lower surface of said saddle body, said back contacting pad defining a recessed gullet region extending along a central region of said saddle body; and
a billet strap secured to said saddle body.

2. A saddle according to claim 1 wherein said billet strap comprises first and second straps riveted to a first side region of said top surface and third and forth straps riveted to a second side region of said top surface.

3. A saddle according to claim 1 further comprising a side panel secured to said top surface of said body.

4. A saddle according to claim 3 wherein side panel includes a pad having a rear surface adapted for positioning a stirrup leather therebehind.

5. A saddle according to claim 3 wherein said side panel includes a stirrup leather keeper positioned at an acute angle with respect to an elongate axis of said body.

6. A saddle according to claim 1 further comprising
a non-rigid pommel manufactured of flexible material, secured to said top surface, and extending upwardly from said seat region; and
a non-rigid cantle manufactured of flexible material, secured to said top surface, and extending upwardly from said seat region opposite said pommel such that said pommel, said cantle and said seat region define a contoured seat adapted for receiving a rider.

7. A saddle according to claim 1 wherein said back contacting pad includes first and second back contacting pads positioned on opposite sides of said recessed gullet region.

8. A saddle according to claim 1 wherein said back contacting pad includes first and second sculpted regions each positioned to received one of the inner thighs of a rider.

9. A saddle according to claim 1 further comprising a removable thigh block.

10. A saddle according to claim 1 further comprising a removable gullet supplement sized to fit within said recessed gullet region.

11. A saddle according to claim 1 further comprising a knee roll secured to said top surface.

12. A frameless, flexible saddle comprising:
a substantially flat, bendable saddle body defining a substantially flat, underside including first and second side regions, and a topside that defines a seat region;
a first pad secured to said underside of said saddle body in said first side region;
a second pad secured to said underside of said saddle body in said second side region, wherein said first and second pads define a recessed region therebetween; and
a knee roll secured to said topside;
wherein said saddle body is flexible individually and simultaneously along each of x, y and z axes.

13. A saddle according to claim 12 further comprising a flexible pommel and a flexible cantle each secured to and extending upwardly from said topside.

14. A saddle according to claim 12 wherein said recessed region defines a gullet extending along a length of said saddle.

15. A saddle according to claim 12 further comprising a gullet pad removably secured within said recessed region.

16. A saddle according to claim 12 further comprising a removable thigh block and a removable a shoulder panel.

17. A saddle according to claim 12 wherein said first pad and said second pad each include a contoured section in a forward region thereof.

18. A saddle according to claim 12 further comprising a billet secured to said topside.

19. A saddle according to claim 12 further comprising a side panel secured to said body, said side panel including a foam pad having a rear surface adapted to position a stirrup strap therebehind.

20. A saddle according to claim 12 wherein said side panel defines a substantially straight forward surface.

21. A flexible, treeless saddle comprising:
a non-rigid saddle body manufactured of flat, flexible material and having a smooth, continuous lower surface and a top surface that defines a seat region;
a non-rigid pommel manufactured of flexible material, secured to said top surface, and extending upwardly from said seat region;
a non-rigid cantle manufactured of flexible material, secured to said top surface, and extending upwardly from said seat region opposite said pommel such that said pommel, said cantle and said seat region define a contoured seat adapted for receiving a rider; and
a side panel secured to said saddle body and adapted for contacting a rider.

22. A saddle according to claim 21 wherein said side panel includes a pad therein, said pad including a rear surface adapted for positioning a stirrup strap therebehind.

23. A saddle according to claim 21 wherein said side panel includes a strip strap holder positioned at an acute angle with respect to an elongate axis of said body.

24. A saddle according to claim 21 wherein said side panel defines a substantially vertical forward surface.

25. A saddle according to claim 21 further comprising a billet strap riveted to said body.

26. A saddle according to claim 21 further comprising a knee roll securely fastened to said top surface of said body.

27. A flexible, treeless saddle comprising:
a non-rigid saddle body manufactured of flat, flexible material and having a smooth, continuous lower surface and a top surface that defines a seat region;
a non-rigid back contacting pad secured to said lower surface of said saddle body, said back contacting pad defining a recessed gullet region extending along a central region of said saddle body; and
a side panel secured to said top surface of said body, said side panel defining a substantially straight front surface.

28. A saddle according to claim 27 wherein said side panel includes a pad that defines a rear surface adapted to inhibit movement of a stirrup strap forwardly of said rear surface.

29. A saddle according to claim 27 further comprising a knee roll secured to said body and beneath said side panel.

30. A saddle according to claim 27 further comprising a billet strap secured to said body and beneath said side panel.

31. A method of manufacturing a fully flexible saddle, comprising the steps of:
providing a flexible, substantially flat saddle body, wherein said saddle body includes a smooth underside and a smooth topside;
securing a side panel to said topside, said side panel including a pad having a rear surface adapted for positioning a stirrup strap therebehind; and
securing a flexible pad to said underside of said saddle body such that said flexible pad extends downwardly from said underside, and wherein said flexible pad defines a recessed gullet region.

32. A method according to claim 31 wherein said side panel includes a top surface adapted for contacting a rider.

33. A method according to claim 31 further comprising attaching a stirrup strap to said body.

34. A method according to claim 33 further comprising securing a portion of said stirrup strap in a stirrup keeper, said stirrup keeper secured on said side panel and positioned at an acute angle with respect to an elongate axis of said saddle.

35. A method according to claim 31 wherein said flexible pad comprises first and second pads each secured to said underside of said saddle body such that said first and second pads define said recessed gullet region therebetween.

36. A method according to claim 31 further comprising securing a billet strap to said body.

37. A method according to claim 31 further comprising securing a knee roll to said topside of said body.

38. A method according to claim 31 wherein said flexible pad defines first and second cutout regions positioned to receive a rider's inner thigh.

39. A method according to claim 31 further comprising adjustably securing a thigh block to said top side of said body.

40. A method according to claim 31 further comprising adjustably securing a gullet pad within said recessed gullet region.
